(19) United States
(12) Patent Application Publication
(10) Pub. No.: US 2016/0264162 A1
(43) Pub. Date: Sep. 15, 2016

(54) IRID IDENTIFICATION SYSTEM

(71) Applicant: AMATEO SP. Z.O.O., Kielce (PL)

(72) Inventor: PIOTR DULKIEWICZ, LANCUT (PL)

(73) Assignee: AMATEO Sp. Z.O.O., KIELCE (PL)

(21) Appl. No.: 14/434,016

(22) PCT Filed: Mar. 31, 2014
(86) PCT No.: PCT/PL2014/000032

§ 371 Date: Apr. 7, 2015

(30) Foreign Application Priority Data
Mar. 26, 2014 (PL) P.407675

(51) Int. Cl. B61L 23/34; G01D 5/40; B61L 25/04

(52) U.S. Cl. CPC B61L 23/34; B61L 25/04; G01D 5/40; B61L 2205/00

(57) ABSTRACT

A IRID object identification system equipped with active identifiers operation of which is based on transmission in the infrared radiation band is characterised in that the identification system uses IRID active identifiers operation of which is based on transmission in the infrared radiation band generated by narrow-angle infrared transmitters whereas a battery (3) of the energy management system (2) is recharged by solar cells (6), and the system comprises a device provided with transmitter (4) and receiver (5) equipped with reader (7). The device (1) of the system makes use directivity of emission in the infrared radiation band to analyse direction of motion of the identifier. This offers the possibility to handle more than one identifier present within the range of reader (7) and thus allows to overlap range areas of a plurality of readers (7) in the barrier or cellular (honeycomb) topology to increase precision of location of objects in a predefined area.

The subject of the present invention is a IRID object identification system for recognising and analysing direction of displacement of an object moving within the area of monitored passages. The system uses two-way transmission initiated by a reader (operating in master/slave technology) with arbitration and collision detection that allows additionally to handle more than one identifier located in the reader's reception range at a time. The system offers the possibility to overlap range areas of many readers allowing thus not only to use it as a point-like unit but also as an element operating in the barrier or cellular (honeycomb) topology for precise location of objects in a predetermined area.

Polish patent description No. 169100 reveals a rail track measuring device designed for measuring characteristic geometric features of railway tracks, in particular track gauge, track inclination, as well as crossover groove width. The invention solves the problem of providing a railway track measuring device guided manually along a track for comprehensive track measurements with requirements of ergonomics taken into account. The railway track measuring device is characterised in that it comprises a body provided with a traction system composed of three connective elements with horizontal axles, two contact rollers with vertical axles setting position of the railway track measuring device with respect of one of the rails of the track, and an expanding-measuring roller with vertical axle mounted on a spring-loaded rolling slide, whereas the track gauge variation measurement is carried out by means of measuring displacement of the expanding-measuring roller with respect to the two contact rollers.

Austrian patent description No. ATA204/99 reveals a method of surveying a track using two independent mobile measuring vehicles characterised in that at first, at the beginning of each measurement cycle realised by means of receiver of a measuring satellite, absolute position of a stationary measuring vehicle is determined with respect to the measuring satellite reference station installed locally within a terrestrial co-ordinate system adjacent to the track section to be measured, and then, on the basis of taking the determined position data into account, the reference line created as a laser beam between transmitter of the stationary measuring vehicle and the receiving unit of the mobile measuring vehicle is aimed at the mobile measuring vehicle and in the course of advancing the mobile measuring vehicle.

Polish patent description P-374368 reveals a system for identification of objects designed for the blind and the visually impaired persons that comprises RFID-type identifiers located on objects that require identification, comprises further a transmitter equipped with a signal generator connected with a collision avoidance system gate connected with a controlled-amplification amplifier provided with a amplification control generation system, and comprises also a mobile RF antenna with position decoder connected with a transmitter and a microprocessor-based readout system comprising a carrier signal detector, a collision avoidance system decode, a decoder of codes red out from RFID identifiers, and a short range radio transmission system transceiver coupled with a voice generator connected to a headphone and coupled with a voice recognition system and a voice command decoder connected with a microphone.

The measurement methods known to date do not provide the possibility to obtain important information characterising different objects or elements of railway infrastructure.

The known invention consists in application of IRID radio-based identification system to acquisition of data on railroad transport infrastructure by using a measuring equipment for both direct and indirect measurements that comprises a system receiver in the form of FRID reader and railway transportation infrastructure elements equipped with identifiers comprising an electronic chip with memory and provided with a FRID transmitter.

The reader operates as a transmitting-receiving device that sends or receives a beam of properly coded electromagnetic radiation saving or reading this way data concerning an element of railway infrastructure. Depending on the type of the device, it is configured with the mileage of train or tram line in question or with geodesic coordinates.

RFID identifiers (tag, transponder, label) comprising an electronic chip with memory and a miniature antenna may have memory capacity ranging from several dozen to several thousand bits. Such capacity is sufficient for most applications and allows to store data characterising a given railway transport infrastructure element.

One of merits of the radio-based identification system is that the exchange of information occurs by means of radio waves and therefore detection of a RFID-type does not require direct visibility of the reading device antenna. RFID identifier can be operated in a wide range of temperatures ensuring identification in places that are hard to reach and where optical methods cannot be applied. Identifiers can be given different forms (a circle, ring, glass capsule, credit card, button, earring, sticker, token, etc.), depending on actual needs and can be mounted in devices constituting components of a railroad transport infrastructure. Data included in measurement reports, on recording tapes, and in numerical data files provide information not only about e.g. geometry of the railway track or condition of technical and maintenance devices, but also characterise such additional features as the crossover type, track curve radius, electric traction pole numbers, etc.

A drawback of these commonly known radio-frequency based identification and access control (RFID) systems is the necessity to ensure that the reader and the identification tag are brought to a rather small distance from each other (usually about a dozen or so centimetres) or, in case of long-range systems (up to a dozen or so meters), the process of reading a tag lacks directivity (the reading can occur in a wide range of solid angle values, in extreme cases even up to 360 degrees around the reader) which makes determination of direction of the motion (input/output) impossible and can be a source of faulty readings in case of more than one identifier (tag) is present in the reader's range. Moreover, operation of several readers located at small distance from each other may prove ineffective because of mutually generated interference.

The purpose of the present invention is to provide a IRID object identification system that will reduce the angular reading angle of active identifiers down to a dozen or so degrees allowing at the same time, depending on actual needs, to ensure that the transmission range of the modulated signal will be from a dozen or so centimetres to several meters and thus create the possibility to construct systems identifying and analysing the direction of flow of personnel or machines in the area of monitored passages.

The essential idea of the invention consists in that the identification system uses active IRID identifiers operation of which is based on transmission in the infrared transmission range with the use of active identifiers in the devices equipped in a battery recharged by solar cells.

One of the merits of the invention are infrared transmitters allowing to reduce the angular range of the identifier reading process to a dozen or so degrees of angle with assuring at the same time that, depending on the needs, the range of the modulated signal in terms of distance will be from a dozen or so centimetres to several meters, whereas the readers have tags equipped with solar cells recharging a battery integrated in the reader unit and make use of directivity of infrared emission to analyse direction of motion of individual identifiers.

Another merit of the solution according to the present invention is the possibility to construct systems recognising and analysing both location and direction of displacement of selected objects in the area of monitored passages. Two-way transmission initiated by the reader (operating in the master/slave technology) with arbitration and collision detection allows to handle more than one identifier present within the reader range. The possibility to overlap range areas of many readers allows to use them not only as point-like systems but also in the barrier-like or cellular (honeycomb) topology which ensures higher precision when locating objects in a predefined area.

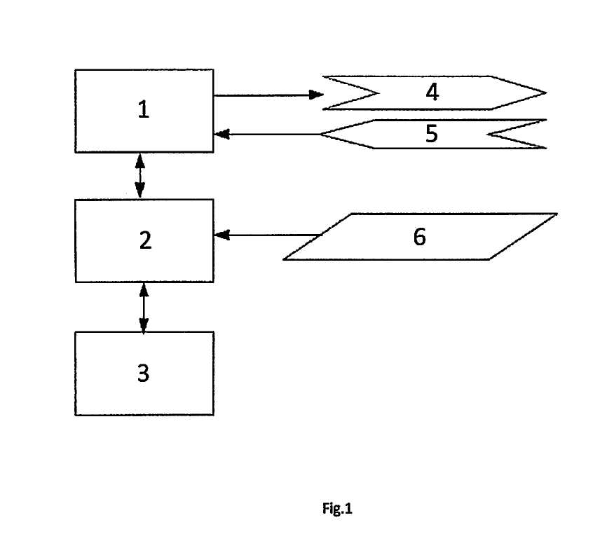

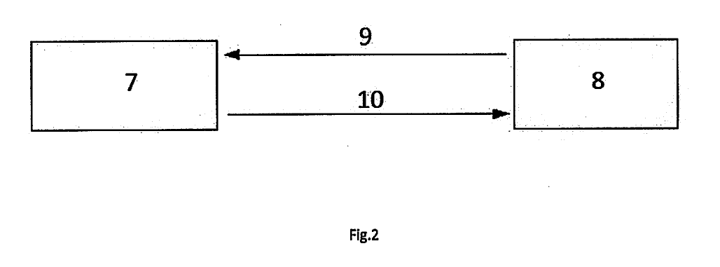

The subject of the invention is shown in the attached figures in the form of block diagrams, of which FIG. 1 presents the system with IRID object identification transmitting-receiving device, and FIG. 2 shows a block diagram of the reader-transponder (identifier) identification process.

The identification system according to the present invention comprises a device 1 in which active identifiers are used operating in the infrared radiation band, whereas the system is characterised in that it employs a plurality of narrow-angle infrared radiation transmitters and has an energy management system comprising solar cells. The transmission-reception device 1 has a transmitter 4 and a receiver 5, and its circuit includes a control logic and an energy management system 2 with a battery 3 recharged by solar cells 6.

FIG. 2. represents the system in the query-response configuration with reader 7 equipped with an identifying transponder 8 and active identifiers operation of which is based on transmission within the narrow beam of infrared transmitters.

1. A IRID object identification system equipped with active identifiers operation of which is based on transmission in the infrared radiation band characterised in that the identification system has a device (1) comprising a transmitter (4) and a receiver (5) as well as a reader (7) in a system of identification of active identifiers based on transmission in the infrared radiation band with the use of narrow-angle infrared transmitters with active identifiers in devices equipped with battery (3) recharged by solar cells (6).

2. The system of claim 1 characterised in that the device (1) makes use of directivity of emission in the infrared radiation band to analyse direction of motion of the identifier.

3. The system of claim 1 characterised in that additionally it allows to handle more than one identifier present at the same time within the range of the reader (7).

4. The system of claim 1 characterised in that it allows to overlap range areas of a plurality of readers (7) in the barrier or cellular (honeycomb) topology to improve precision of location of objects in a predefined area.
